(19) United States
(12) Patent Application Publication
(10) Pub. No.: US 2007/0000725 A1
(43) Pub. Date: Jan. 4, 2007

(54) Ladder stabilizer apparatus

(76) Inventor: Jerry D. Bell, Milwaukee, WI (US)

Correspondence Address: Galasso & Associates, LP, P.O. Box 26503, Austin, TX, 78755-0503, US

(21) Appl. No.: 11/449,988

(22) Filed: Jun. 9, 2006

Related U.S. Application Data
(60) Provisional application No. 60/690,045, filed on Jun. 11, 2005.

(51) Int. Cl. E06C 1/00

(52) U.S. Cl. 182/172

(57) ABSTRACT

A ladder stabilizing apparatus is provided for a ladder having two distally spaced vertical rails. The stabilizer apparatus comprises a mounting bracket configured for mounting onto and against the base portion of the side rails of a ladder. The stabilizer includes an elongated rectangular shaped ground pad member which is hingeably attached to the mounting bracket such that the ground pad is free to pivot between a folded position where it rests against the side of the mounting bracket and therefore against the side of the ladder side rail, to a second open and supportive position wherein the ground pad pivots about the hinge to a position in which it is substantially perpendicular to the mounting bracket and to the vertical side rail of the ladder. The stabilizer further includes an elongated folding locking strut member to hold the ground pad in a supportive position, providing the ladder with a wider base, a larger area over which to distribute the weight and improved resistance to tip over of the ladder.

### CROSS REFERENCE TO RELATED APPLICATIONS

This application claims priority to co-pending U.S. Provisional Patent Application having Ser. No. 60/690,045 filed Jun. 11, 2005 entitled “Stationary Arms”, having a common applicant herewith.

### FIELD OF THE DISCLOSURE

The disclosures made herein relate generally to ladders, extension ladders and more particularly to apparatuses for stabilizing such ladders against tipping.

### BACKGROUND

Ladders are well known and are commonly used in a wide variety of commercial and personal tasks including home improvement, construction, and other uses whenever it is desired to climb to a height to perform work or to reach an elevated object placed out of human reach. Early forms of ladders were often constructed of wood members having two elongated leg members with cross rails or steps spaced at regular intervals up the legs and attached there between. Over years of use and development ladder materials have evolved beyond traditional wood construction into the use of aluminum and more recently fiberglass, all in a trend to yield a lighter weight ladder, one which is easier to transport and to move around and position for use.

Ladders are commonly seen and available in two major forms, step ladders and extension ladders. By extension ladders herein, we include single section ladders. Step ladders have a folding ‘A’ shaped configuration having four legs and are by design self supporting when placed on flat level surfaces. Extension ladders on the other hand have two parallel legs with a plurality of rungs there-between. Extension ladders can be used as a single section but are frequently two or three section ladders, the sections being individually moveable two legged ladder sections that are mounted in a parallel fashion to the back of the first or subsequent section. Multiple section extension ladders can be extended by positionally sliding the sections relative to each other until a composite extension ladder with the desired height or reach is obtained. After use, the extension ladder can be collapsed by sliding the sections together to reduce the size for transport. All of the above is old and well known in the art but presented herein as background on the field to which the inventive disclosure pertains.

Unlike step ladders, extension ladders are not self supporting but instead must rest the upper portion of the ladder against another supportive surface such as the wall of a building or a tree branch or other supportive stationary object. While extension ladders have demonstrated by years of use over time to be essential tools, they have certain limitations due to their design. Extension ladders, once extended to reach a relatively long distance above the floor or resting surface, are relatively unstable; this instability increases dramatically with the total extended height of the extended sections. This can be understood as the ladder receives support on the ground from two legs that are relatively close together in a fixed distance relationship, the leg distance being small particularly in relation to the height of the ladder extension. Placing a mass on the ladder in some position up on the ladder, the mass for example being a workman, makes the ladder prone to toppling over, resulting in bodily injury. The vertical side rails of conventional extension ladders typically have rather small base footprints where the footprint is the area of the surface at the bottom of the side rail that is in direct contact with and transfers force or weight supportively to the ground or support surface. When an extension ladder is used outdoors, for example when placed against the exterior wall of a home to paint the second floor shutters, the earthen ground on which the ladder side rails rest is often soft and compressible in comparison to a concrete floor for example. When an extension ladder is used in such conditions, the weight of the ladder and the worker on the ladder can cause the base of one or both side rails to sink into the ground, often in an uneven fashion, thereby contributing to the ladder tipping and falling over.

As can be readily understood by those familiar with the use of ladders, the ideal alignment of the ladder is with the ladder side rails extending upwards substantially vertically when viewed from the base of the ladder. This is such that the ladder rungs are substantially perpendicular to the vector force of gravity. By analysis, the vertical center of gravity of the ladder and worker plus materials supported thereby must lie vertically between the two legs of the ladder such that weight is shared in some proportion between the two legs. If the ladder is permitted to tilt sufficiently to one side such that this vertical center of gravity no longer lies between the ladder legs when projected vertically to the support surface, then laws of Physics or a simple review of a Statics text will show the ladder will tend to tip. Of course injury is likely to occur if it does. It is important to appreciate that the longer or higher the ladder is in its extension, the less tolerant it is in any misalignment and the easier it is for the ladder to tip. A ladder of a given height can be designed so as to be more resistant to tipping by extending the spacing between the vertical rails of the ladder. For conventional ladders the spacing between the side rails is fixed and can not be further displaced at will, so another approach is needed to make the ladder more resistant to tipping.

Therefore, a ladder stabilizing apparatus which is designed for installation onto the vertical side rails of conventional ladders and extension ladders, a stabilizer which is light in weight and conveniently folds against the ladder side rails when not in used, a ladder stabilizer which greatly increases the base footprint of the ladder's vertical side rails, thereby spreading the weight of the ladder plus occupant and other supported loads over a larger surface area on the ground and thereby reducing the tendency of the ladder to compress the ground and lead to tipping of the ladder, a stabilizer that when in use extends outwards from the base portion of the ladder side rails providing a stabilizing effect similar to an increase in the distance between the ladder side rails where the side rails contact the ground and thereby improve stability and reduce the chance of tipping of the ladder, such a ladder stabilizing apparatus would be useful and novel.

### SUMMARY OF THE DISCLOSURE

Accordingly, embodiments of the inventive disclosures made herein comprise various embodiments of a ladder stabilizing apparatus which are generally used in pairs and designed to be installed on to the vertical side rails of a ladder at a portion near the base of the side rail.

In embodiments of the inventive disclosures made herein, a ladder stabilizing apparatus is provided for a ladder having two distally spaced vertical rails bridged by a plurality of rungs. The stabilizer apparatus comprises a mounting bracket having substantially flat front and rear surfaces. The mounting bracket sized and configured for mounting onto and against an outward facing side of a ladder side rail such that it is proximate to a base portion of the rail. The stabilizer further includes a first hinge member which is secured to the ground facing first edge of the mounting bracket. An elongated ground pad member has a mating hinge member that hingeably engages the first hinge member of the mounting bracket such that the ground pad is free to pivot between a folded position where it rests against the side of the mounting bracket and therefore against the side of the ladder side rail, to a second open and supportive position in which it is substantially perpendicular to the mounting bracket and to the vertical side rail of the ladder. In the open and supportive position the ground pad is coplanar with the bottom of the side rails and in a substantially facing relationship with the ground. The stabilizer further includes an elongated folding and locking strut member bridging between and connecting portions of the mounting bracket to the support pad. The folding strut member comprises an elongated upper strut having a first end and a second end, as well as an elongated lower strut having a first end and a second end. The upper or first end of the lower strut is hingeably secured to the lower or first end of the upper strut such as to form a folding strut member. The folding strut member includes a means of releasably locking the upper and lower struts into an axial alignment position. The strut member is configured to lock the ground pad into a supportive position in which the ground pad is pivoted about the hinge to a position where it is substantially perpendicular to the mounting bracket. The upper end of the upper strut is hingeably secured to the front surface of the mounting bracket. Similarly the low end of the lower strut is hingeably attached to the top surface of the ground pad member. The length of the strut member and hinge locations are chosen such that by axially aligning and locking the strut alignment the strut member positions the ground pad member at substantially right angles to the mounting bracket, while unlocking the strut member permits the ground pad member to pivot into a facing relationship with the mounting bracket so as to fold against the ladder rail for transport or storage.

In another embodiment of the inventive disclosures made herein, the ground pad of the ladder stabilizing apparatus is substantially flat and rectangular in shape.

In yet another embodiment of the inventive disclosures made herein, the stabilizer apparatus is provided with the ladder as one piece rather than as a separate add-on component.

In one or more embodiments of the inventive disclosures made herein, the elongated folding strut member has a first pin which is received and secured into the first holes of the upper and lower struts, the pin hingeably joining the upper and lower struts, and the means of releasably locking the strut comprises an elongated sliding lock sleeve member having a void between two opposing ends of the lock member where the lock member void is sized and adapted such that the lock member is received over and slidable along the upper strut. The lower strut includes a lock member stop secured to the lower strut. The stop enforces a lower position limit to the travel of a sliding lock member upon the strut so as to hold the lock member in position over the hinged pivot between the upper and lower struts, thereby locking the upper and lower struts into axial alignment. The lock member is slidable up upon the upper strut to release the axial alignment lock and permit the upper and lower struts to hingeably pivot about the pin.

In one or more embodiment of the inventive disclosures made herein, the hinge members that hingably attach one strut to the mounting bracket and the other strut to the ground pad comprise a spaced pair of tabs having a hole through each tab, the tabs secured to a front surface of the mounting bracket. The tabs spaced apart and configured to permit the second end of the upper strut to be received between the tabs. A pin is received through the hole in the tabs and through the second hole in the upper strut such that the pin tabs and hole forming a hinge mount of the upper strut to the mounting bracket. Additionally a spaced pair of tabs having a hole through each tab is secured to the top surface of the ground pad. The tabs are spaced apart and configured to permit the second end of the lower strut to be received between the tabs on the ground pad. A pin is received through the hole in the tabs and through the second hole in the lower strut such that the pin tabs and hole form a hinge mount of the lower strut to the ground pad.

In one or more embodiment of the inventive disclosures made herein, the ladder stabilizer apparatus comprises steel.

It is an objective of the inventive disclosure made herein to provide a ladder stabilizer apparatus that can be used with a variety of ladders.

It is an objective of the inventive disclosure made herein to provide a ladder stabilizing apparatus that is light in weight and may conveniently fold against the ladder side rails when not in use.

It is an objective of the inventive disclosure made herein to provide a ladder leveling apparatus which greatly increases the base footprint interface area of the ladder's vertical side rails on the ground, thereby spreading the weight of the ladder plus occupant and other supported loads over a larger ground contact surface area thereby reducing the tendency of the ladder to compress the ground and lead to tipping of the ladder.

It is an objective of the inventive disclosure made herein to provide a ladder leveling apparatus that when in use extends outwards from the base portion of the ladder side rails providing an effect similar to an increase in the distance between the ladder side rails where the side rails contact the ground and thereby improve stability and reduce the chance of tipping of the ladder.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 presents a perspective view of one embodiment of a ladder stabilizing apparatus in use and attached to the base portion of the extension ladder.

FIG. 2 presents a perspective view of one embodiment of a ladder stabilizing apparatus showing features of the ladder mounting bracket, the ground pad and folding strut member.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

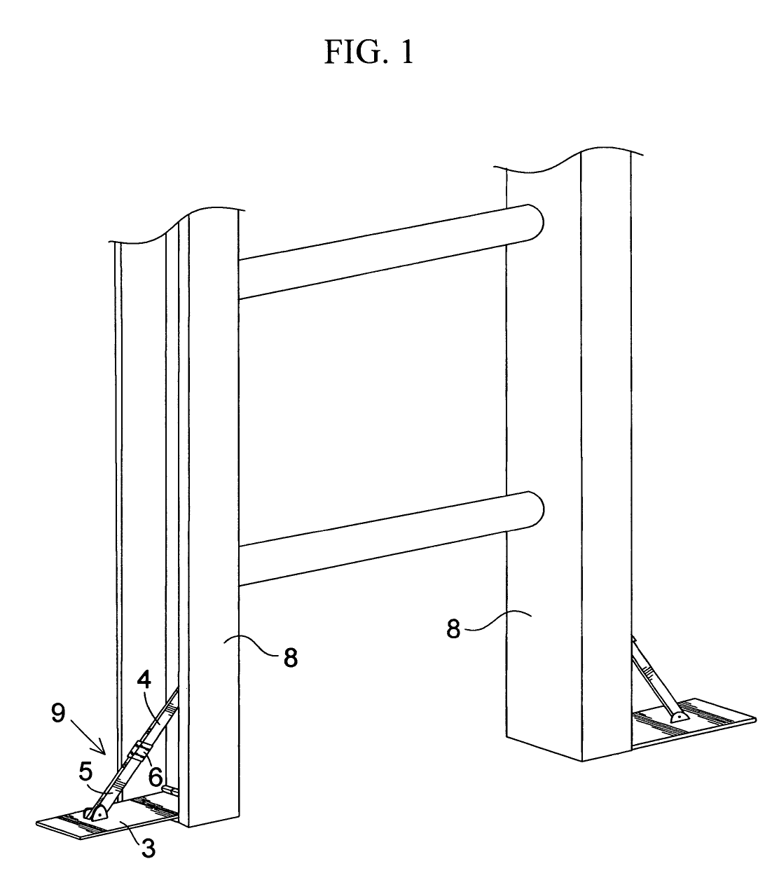

FIG. 1 presents a perspective view of one embodiment of a ladder stabilizing apparatus in use and attached to the base portion of an extension ladder. The ladder stabilizing apparatus has a rectangular and substantially flat mounting bracket (not shown in this view) which is secured to the distally spaced substantially vertical side rails 8 of the ladder. A flat rectangular ground pad 3 is hingably connected to the mounting plate along a lower or ground facing edge of the mounting bracket. An elongated locking folding strut member 9 is hingably connected at an upper end to the mounting bracket as well as hingably connected at the lower end of the strut member to the ground pad 3. An elongated sliding sleeve lock member 6 is slidable along the upper strut. The lock member 6 is configured to lock the upper 4 and lower 5 struts into an axially aligned position when the lock member is positioned over the hinged connection between the upper and lower struts. The lock member 6 is slidable upwards on the upper strut to release the axial alignment lock and permit the upper 4 and lower 5 struts to hingeably fold to pivot the ground pad 3 into a storage position facing the mounting bracket and ladder side rail 8.

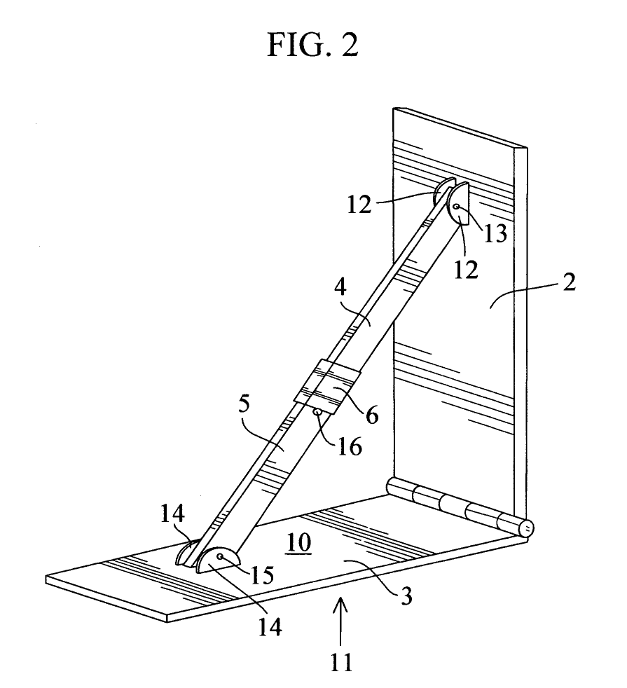

FIG. 2 presents a perspective view of one embodiment of a ladder stabilizing apparatus showing features of the ladder mounting bracket 2, the ground pad 3 and folding strut member. The mounting bracket 2 has substantially flat front and rear surfaces. The mounting bracket 2 is sized and configured for mounting onto an outward facing side of the ladder side rail in a location proximate to the base portion of the rail of the ladder. The stabilizing apparatus further includes an elongated ground pad member 3 having a top surface 10 and a bottom surface 11 for resting supportively upon the ground. The ground pad 3 is connected to the mounting bracket 2 by a hinge 7 such that the ground pad can pivot between a first position substantially parallel to and facing the mounting bracket, to a second supportive position extending outwards from the mounting bracket and substantially perpendicular to the mounting bracket. In the supportive position the bottom surface 11 of the ground pad 3 is substantially coplanar to the bottom ends of the side rails of the ladder (ladder shown in FIG. 1).

An elongated folding strut member interconnects portions of the mounting bracket to the ground pad. The folding strut comprises an elongated upper strut 4 having an upper end hingably connected to a front surface of mounting bracket 2. The hingable connection comprises a spaced pair of tabs 12 having a hole through each tab. The tabs 12 are secured to a front surface of the mounting bracket 2. The tabs are spaced apart and configured to permit the upper portion of the upper strut 4 to be received between the tabs. A pin 13 is received through the hole in the tabs and through a hole in the upper strut such that the pin, tabs and holes form a hinge mount of the upper strut to the mounting bracket. Additionally, a spaced pair of tabs 14 having a hole through each tab are secured to the top surface 10 of the ground pad 3. The tabs 14 are spaced apart and configured to permit the lower end of the lower strut 5 to be received between the tabs 14 on the ground pad 3. A pin 15 is received through the hole in the tabs and through the hole in the lower portion of the lower strut such that the pin, tabs and holes form a hinge mount of the lower strut 5 to the ground pad 3. An elongated sliding sleeve lock member 6 is slidable along the extent of the upper strut 4. The lock member 6 is configured to lock the upper 4 and lower 5 struts into an axially aligned position when the lock member 6 is positioned over the ends and hinged connection between the upper and lower struts (illustrated position). The lower strut includes a lock member stop 16 secured to the lower strut. The stop is envisioned as a protrusion fabricated on the lower strut that enforces a lower position limit to the travel of a sliding lock member upon the strut so as to hold the lock member in position over the hinged pivot between the upper and lower struts, thereby locking the upper and lower struts into axial alignment. The stop may be fabricated on the lower strut by a process such as stamping, or by any other means of placing a stop on the lower strut as would be known to those skilled in the art. The lower strut is hingably connected to the upper strut by a hinge member (not shown, present behind locking member 6). The hinge member between the upper and lower struts is envisioned as a pin received and secured into aligned holes in the mating ends of the upper strut 4 and lower strut 5. The lock member 6 is slidable upwards on the upper strut to release the axial alignment lock and permit the upper 4 and lower 5 struts to hingeably fold so as to pivot the ground pad into a storage position facing the mounting bracket 2.

The discussed construction, illustrations and sequence of operation is for one embodiment of the invention but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A ladder stabilizer apparatus for a ladder having two distally spaced vertical rails bridged by a plurality of rungs, the stabilizer apparatus comprising:
a mounting bracket having substantially flat front and rear surfaces, the mounting bracket sized and configured for mounting onto an outward facing surface of the side rail proximate a base portion of the rail;
a first hinge member secured to a ground facing first edge of the mounting bracket;
an elongated ground pad member having a top surface, a bottom surface for resting supportively upon the ground, and two opposing ends;
a complimentary second hinge member secured to the first end of the ground pad member, the second hinge member sized and adapted to hingeably engage with the first hinge member such that the ground pad member can pivot outwards from the mounting bracket;
an elongated folding strut member, the strut member comprising:
an elongated upper strut having a first end and a second end;
an elongated lower strut having a first end and a second end, the first end of the lower strut hingeably secured to the first end of the upper strut; and
a means of releasably locking the upper and lower struts into axial alignment, wherein the strut is enabled to fold to permit the ground pad to pivot on the hinge to align in a facing position to the mounting bracket, and wherein the strut is enabled to hingeably unfold and lock the ground pad into a supportive position in which the ground pad pivots about the hinge to a position where it is substantially perpendicular to the mounting bracket and locks into this position;
a second hinge member hingeably attaching the second end of the upper strut to the front surface of the mounting bracket; and
a third hinge member hingeably attaching the second end of the lower strut to the top surface of the ground pad member, wherein axially locking the strut member positions the ground pad member at substantially right angles to the mounting bracket; and unlocking the strut member permits the ground pad member to pivot into a facing relationship with the mounting bracket.

2. The ladder stabilizer apparatus of claim 1, wherein the ladder has two stabilizer apparatuses, one secured to the base portion of each vertical rail.

3. The ladder stabilizer apparatus of claim 1, wherein the ground pad is substantially flat and rectangular in shape.

4. The ladder stabilizer apparatus of claim 1, wherein the stabilizer apparatus is provided with the ladder as one piece.

5. A ladder stabilizer apparatus for a ladder having two distally spaced vertical rails bridged by a plurality of rungs, the stabilizer apparatus comprising:
a mounting bracket having substantially flat front and rear surfaces, the mounting bracket sized and configured for mounting onto an outward facing side of the side rail proximate a base portion of the rail;
a first hinge member secured to a ground facing first edge of the mounting bracket;
an elongated ground pad member having a top surface, a bottom surface for resting supportively upon the ground, and two opposing ends;
a complimentary second hinge member secured to the first end of the ground pad member, the second hinge member sized and adapted to hingeably engage with the first hinge member such that the ground pad member can pivot outwards from the mounting bracket;
an elongated folding strut member, the strut member comprising:
an elongated upper strut having a first hole and a second hole, the first hole located proximate to a first end of the upper strut, and the second hole located proximate to a second end of the upper strut;
an elongated lower strut having a first hole and a second hole, the first hole located proximate to a first end of the lower strut, and the second hole located proximate to a second end of the lower strut;
a first pin received and secured into the first holes of the upper and lower struts, the pin hingeably and foldably joining the upper and lower struts;
an elongated sliding lock sleeve member having a void between two opposing ends of the lock member, the lock member void sized and adapted for the lock member to be received over and slidable along the upper strut;
a lock member stop secured to the lower strut, the stop enforcing a lower position limit to the travel of a sliding lock member upon the struts; and
the elongated sliding lock member having a void between two opposing ends of the lock member, the lock member void sized and adapted for the lock member to be received over and slidable along the struts, the lock member configured to lock the upper and lower struts into an axially aligned position when the lock member is positioned over the first ends of the upper and lower struts, the lock member slidable upwards upon the upper strut to release the axial alignment lock and permit the upper and lower struts to hingeably fold;
a second hinge member hingeably attaching the second end of the upper strut to the front surface of the mounting bracket; and
a third hinge member hingeably attaching the second end of the lower strut to the top surface of the ground pad member, wherein axially locking the strut member positions the ground pad member in a tip resistant supportive position at substantially right angles to the mounting bracket, and unlocking the strut member enables the ground pad member to pivot into a facing relationship with the mounting bracket.

6. The ladder stabilizer apparatus of claim 5, wherein the second hinge member comprises:
a spaced pair of tabs having a hole through each tab, the tabs secured to and projecting outwards from a front surface of the mounting bracket, the tabs spaced apart and configured to permit the second end of the upper strut to be received between the tabs; and
a pin received through the hole in the tabs and through the second hole in the upper strut, the pin, tabs and holes forming a hinge mount of the upper strut to the mounting bracket.

7. The ladder stabilizer apparatus of claim 6, wherein the third hinge member comprises:
a spaced pair of tabs having a hole through each tab, the tabs secured to and projecting upwards from a top surface of the ground pad, the tabs spaced apart and configured to permit the second end of the lower strut to be received between the tabs; and
a pin received through the hole in the tabs and through the second hole in the lower strut, the pin, tabs and hole forming a hinge mount of the lower strut to the ground pad.

8. The ladder stabilizer apparatus of claim 7, wherein the ground pad is substantially flat and rectangular in shape.

9. The ladder stabilizer apparatus of claim 8, wherein the stabilizer apparatus comprises steel.
